(19) United States
(12) Patent Application Publication
(10) Pub. No.: US 2020/0109960 A1
(43) Pub. Date: Apr. 9, 2020

(54) TOLL TRACKING AND ESTIMATING SYSTEM

(71) Applicant: Firas Al-Jazrawi, Mississauga (CA)

(72) Inventor: Firas Al-Jazrawi, Mississauga (CA)

(21) Appl. No.: 16/594,050

(22) Filed: Oct. 6, 2019

Related U.S. Application Data
(60) Provisional application No. 62/742,296, filed on Oct. 6, 2018.

(51) Int. Cl. G01C 21/34; G01C 21/36

(52) U.S. Cl. CPC G01C 21/3461; G06Q 2240/00; G01C 21/3667; G01C 21/3697

(57) ABSTRACT

The present invention relates to a system for tracking and displaying toll charges in real-time, the system including: a trip planning module, the trip planning module including a user interface for user input of a destination location, a route calculation module capable of calculating one or more routes for travel from a starting location to the destination location and displaying the one or more routes to the user for selection, a toll estimation module capable of calculating estimated toll charges along each of the one or more routes based on data from a toll charge database; wherein, during travel along the selected route, the route calculation module generates real-time updates of current toll charges and estimated arrival time along the selected route for display to the user.

### FIELD OF THE INVENTION

The present specification relates generally to a system and method for tracking toll charges and, in particular, to a system and method for real-time estimating and tracking of toll charges during road travel.

### BACKGROUND OF THE INVENTION

Road travel via automobile or truck, is ubiquitous in modern society, whether for work, leisure, or cargo transportation. The need to create and maintain a vast network or roads has led to many cities and regions operating toll roads, where the user pays a fee, often based on distance travelled, for the use of the road.

However, toll charges tend to be opaque and post-date the actual travel, leading vehicle users with a great deal of uncertainty as to whether a specific toll road provides a travel time advantage in exchange for the toll charge of using the road.

While there are some systems know in the art for tracking a vehicle for the purpose of charging tolls, it would be advantageous to provide real-time information to the vehicle user of expected toll charges during travel. It would be even more advantageous to provide real-time information on alternative routes and the effect on time and toll charges for the user to select an alternative route.

Accordingly, there remains a need for improvements in the art.

### SUMMARY OF THE INVENTION

In accordance with an aspect of the invention, there is provided a system and method for tracking toll charges and, in particular, to a system and method for real-time estimating and tracking of toll charges during road travel.

According to an embodiment of the invention, there is provided a system for tracking and displaying toll charges in real-time, comprising: a trip planning module, the trip planning module comprising a user interface for user input of a destination location, a route calculation module capable of calculating one or more routes for travel from a starting location to the destination location and displaying the one or more routes to the user for selection, a toll estimation module capable of calculating estimated toll charges along each of the one or more routes based on data from a toll charge database; wherein, during travel along the selected route, the route calculation module generates real-time updates of current toll charges and estimated arrival time along the selected route for display to the user.

Additionally, the system may further comprise the route calculation module generating and displaying alternative routes to the user for selection during travel along the selected route, the alternative routes indicating a change in toll charge and estimated arrival time relative to the selected route.

According to another embodiment of the invention, there is provided a method for tracking and displaying toll charges in real-time, comprising: receiving a starting location and a destination location; calculating one or more routes between the starting location and destination location, including estimating travel time and toll charges along each of the one or more routes; displaying the one or more routes for user selection; receiving a selected one of the one or more routes; monitoring travel along the selected route in real-time and; displaying real-time updates of estimated arrival time at the destination location, accrued toll charges and future toll charges along the selected route.

Additionally, the method may further comprise calculating one or more alternative routes during travel and displaying, for user selection, the alternative routes including changes in estimated arrival time and toll charges for each alternative route compared to the selected route.

According to still another embodiment of the invention, a non-transient computer medium is provided containing instructions for executing one or more of the above methods.

Other aspects and features according to the present application will become apparent to those ordinarily skilled in the art upon review of the following description of embodiments of the invention in conjunction with the accompanying figures.

### BRIEF DESCRIPTION OF THE DRAWINGS

Reference will now be made to the accompanying drawings which show, by way of example only, embodiments of the invention, and how they may be carried into effect, and in which:

FIG. 1 is a schematic diagram of an operating environment for a toll tracking system according to an embodiment of the present invention;

FIG. 2 is a block diagram of a toll tracking system according to an embodiment of the present invention;

FIG. 3 is a flowchart of a use process for the toll tracking system of FIG. 2.

FIG. 4 is a simulated display of route;

FIGS. 5 and 6 are simulated displays of real-time route alternatives;

FIG. 7 is a simulated display of an individual trip summary; and

FIG. 8 is a simulated display incorporating warning icons.

Like reference numerals indicated like or corresponding elements in the drawings.

### DETAILED DESCRIPTION OF THE EMBODIMENTS

The present invention relates to relates generally to a system and method for tracking toll charges and, in particular, to a system and method for real-time estimating and tracking of toll charges during road travel.

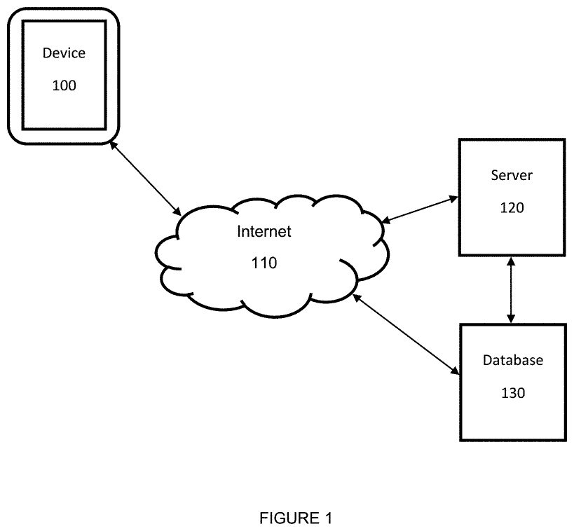

According to an embodiment as shown in FIG. 1, a toll tracking system 200 may be provided as a software application on a user device 100 which communicates with a remote server 120 via the Internet 110. The remote server 120 is in communication with one or more databases 130, the databases containing travel information including, but not limited to, maps, toll route identification and toll amounts associated with toll routes. The user device may be a phone, tablet or built-in vehicle navigation system, or other device capable of determining the vehicle's position via GPS or other means.

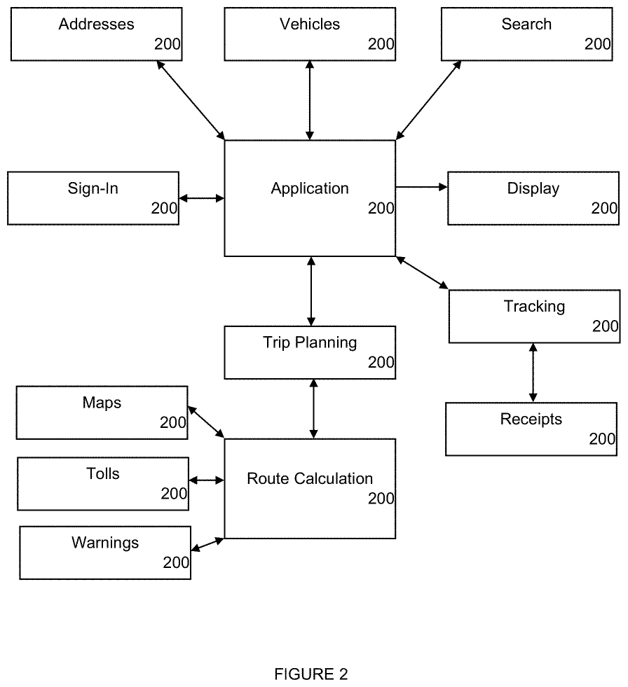

Referring to FIG. 2, the toll tracking system 200 is comprised of one or more modules, the modules including, but not limited to the following types. A sign-in module 210 permits the user to login to a user account in order to access saved user information. The account may be protected via a password or equivalent (fingerprint, face recognition, etc.). Once accessed, the saved user information may be accessed through the separate modules. An address module 220 may contain a list of saved addresses associated with the user account for ease of access. The saved addresses may be displayed as the actual address, and/or with a nickname designation set by the user (e.g. “Home”, “Work”, “School”, etc.). The address module 220 further includes an interface to allow the user to add, edit and delete addresses and nicknames. A vehicle module 230 may contain a list of vehicles associated with the user, including vehicle information such as vehicle type, license plate number, and toll transponder number. The vehicle module 230 may also include an interface to allow the user to add, edit and delete vehicle information.

A search module 240 may also be included with an interface to enable the user to search for desired locations, either by providing full or partial address information, or by providing a keyword (e.g. “restaurant”, “gas station”, “hospital”). The search module may be coupled to one or more databases of address and map information, and may display search results as a list or as a map display with indicators.

A trip planning module 250 may be provided to enable a user to schedule present and future trips. The trip planning module 250 may include a user interface to enable the input of trip data, the trip data including, as required, a destination address, a starting address, a desired arrival time and a desired departure time. The destination address and starting address, if used, may be retrieved from the address module, if contained therein. The arrival time or departure time may be calculated from each other using the address information. The trip planning module 250 then accesses a route calculation module 260 to plan one or more routes between the starting location and the destination location. The route calculation module 260 incorporates the trip information from the trip planning module 250, as well as map data 265, toll data 275 and warning (e.g. construction, accident, etc.) data 285 to calculate the routes along with an estimated arrival time and expected toll charges, if present, along each route. The trip planning module 250 may further include a notification module to notify the user of an upcoming scheduled trip, including impending departure time and estimated arrival time.

Once the user has selected a route, a tracking module 270 monitors the vehicle's position along the route using GPS or similar technology, and the toll tracking system 200 outputs the data from the tracking module 270 to a display 280. Once the trip is complete, the tracking module 270 records the trip information, including data, time distance travelled and tolls accrued, in a receipt module 290 for future user reference.

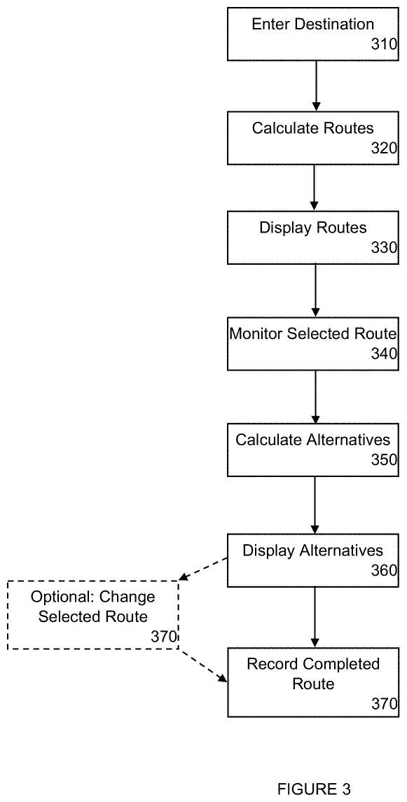

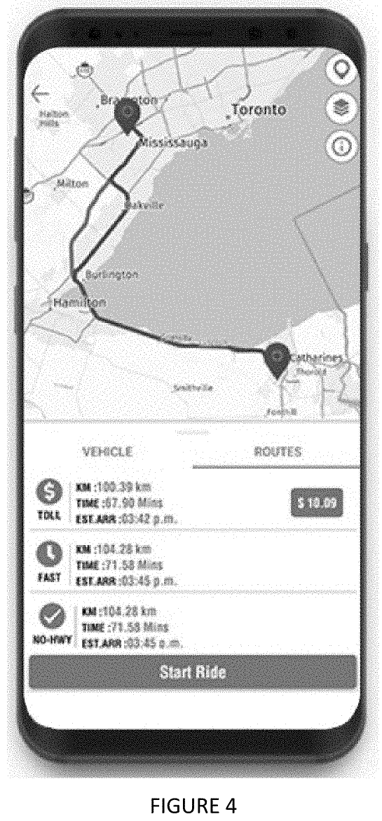

In operation, as shown in FIG. 3, the user accesses the trip planning module enters a destination location 310 for road travel (and optionally, a starting location, if different from the user's current location). The software application then calculates 320 and displays 330 at least two options for the travel route to the destination location as shown in FIG. 4. The software application may also advise the user where any of the routes has a toll charge associated with travel over at least a portion of the route. The estimated travel time and toll charges (if necessary) are presented for each route, enabling the user to select the route that meets both their time and monetary budget requirements.

Identified toll charges for may be fixed or based on distanced travelled (either fixed between entrances/exits or mileage-based) and may further includes fixed charges and surcharges (e.g. HOV lane charges). The toll information may be stored in a database associated with the application on the user device or retrieved from a remote database where available. The toll information may also be estimated based on collected data from other users through the software application or other sources. Preferably, the toll information is updated in real-time to reflect the most current toll charge calculations and amounts. Once the user selects the route, the final estimate of travel time and toll charges are calculated and displayed.

Once a route is selected and the user begins travelling, the application then monitors 340 the vehicle's location and route via GPS or similar means. This updated vehicle location continually calculated against the destination location, thus continually updating the possible alternative routes 350 for travel. Remaining time (as duration or local time or both) to arrival and distance remaining may also displayed for reference. Additionally, the vehicle location is used to estimate the toll charges associated with the both current and future travel to the destination location. This information is displayed to the user in real time to monitor elapsed and estimated travel time and accrued and projected toll charges as they travel. Toll charge estimates are calculated from the vehicle's location and route travelled as mapped against the toll information database.

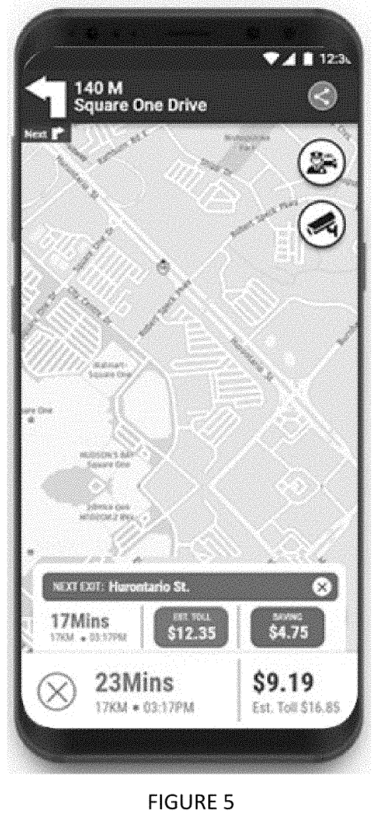

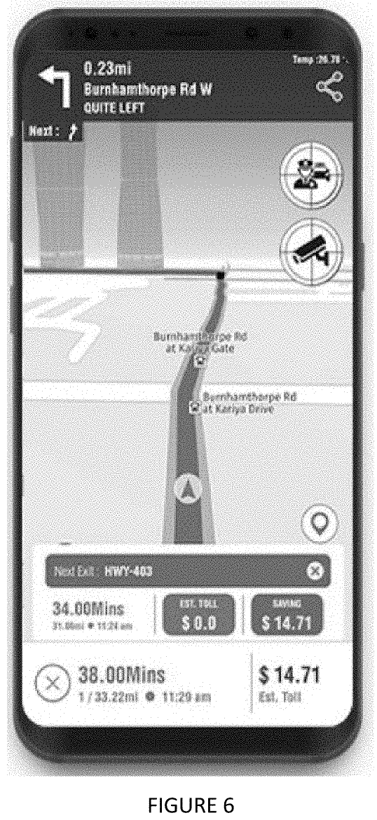

When the vehicle is approaching a location where a route alternative is available (e.g. intersection, on-ramp, off-ramp), the alternative route is displayed 360 along with the current route, along with the estimated difference in travel time and toll cost for the alternative route as shown in FIGS. 5 and 6. The user may then decide whether to continue on the current route or to travel on the presented alternative route 370. This process continues until the destination is reached or there are no further alternative routes. Depending on user preferences, alternative routes may be presented as favorable or unfavorable with respect to changes in estimated arrival time and/or toll charges.

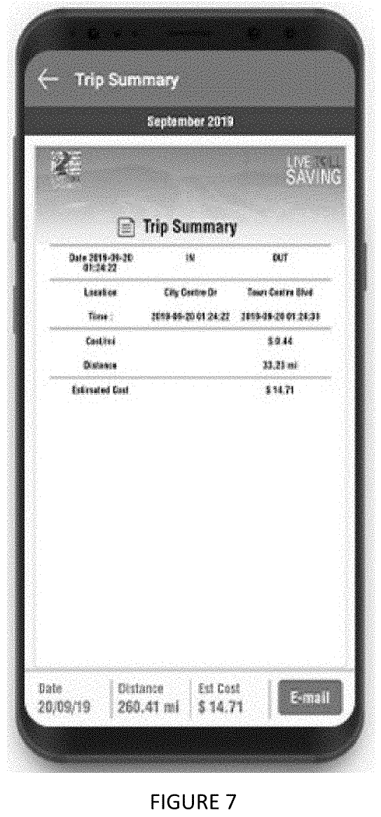

Once the trip is completed, the system generates, records and displays a report of the trip 380 as shown in FIG. 7, including estimated toll costs, along with time, mileage, and any other data are determined by the system and the user. Similar reports may be generated on a daily, weekly, monthly and/or yearly basis for the user's reference. These reports may be used by the user to confirm future toll charges and invoicing by the toll operators. The user may also opt to share the data with the system to verify accuracy of toll estimations, along with time and mileage data.

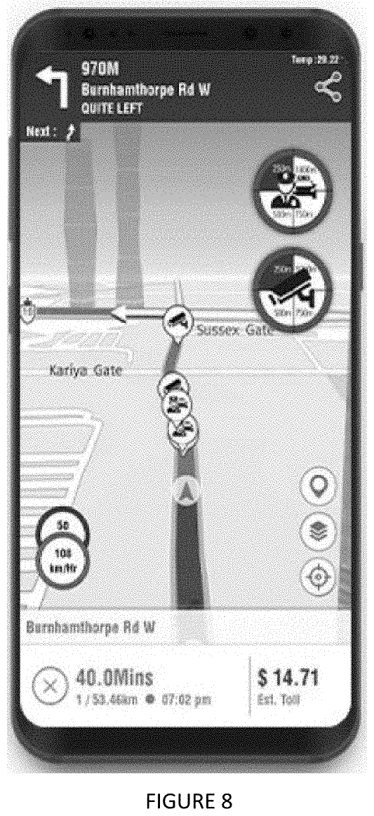

The route information presented to the use may include additional non-toll information, such as speed limits, presence of police and traffic cameras, and weather, traffic and accident information as shown in FIG. 8. This additional non-toll information may be incorporated into the determination as to whether an alternative route is favorable or unfavorable. For example, a route that is normally favorable may have an increased time estimate due to traffic from an accident and be presented as unfavorable. Similarly, a route that is normally unfavorable may be preferred if the present route has a speed limit reduction due to construction.

The present invention may be embodied in other specific forms without departing from the spirit or essential characteristics thereof. Certain adaptations and modifications of the invention will be obvious to those skilled in the art. Therefore, the presently discussed embodiments are considered to be illustrative and not restrictive, the scope of the invention being indicated by the appended claims rather than the foregoing description and all changes which come within the meaning and range of equivalency of the claims are therefore intended to be embraced therein.

What is claimed is:

1. A system for tracking and displaying toll charges in real-time, comprising:
a trip planning module, the trip planning module comprising a user interface for user input of a destination location,
a route calculation module capable of calculating one or more routes for travel from a starting location to the destination location and displaying the one or more routes to the user for selection,
a toll estimation module capable of calculating estimated toll charges along each of the one or more routes based on data from a toll charge database;
wherein, during travel along the selected route, the route calculation module generates real-time updates of current toll charges and estimated arrival time along the selected route for display to the user.

2. The system of claim 1, wherein, during travel along the selected route, the route calculation module generates and displays alternative routes to the user for selection, the alternative routes indicating a change in toll charge and estimated arrival time relative to the selected route.

3. The system of claim 1, wherein the route calculation module further comprises route warning data when calculating routes.

4. The system of claim 3, wherein the route warning data includes one or more of: construction warning, accident warnings and police warnings.

5. The system of claim 1, further comprising a user sign-in module, the user sign-in module capable of associating the selected route with the user and storing user data and route data.

6. The system of claim 5, further comprising a vehicle module, the vehicle module capable of storing vehicle data associated with one or more vehicles associated with the user and associating the selected route with one of the one or more vehicles.

7. The system of claim 5, further comprising a receipt module, the receipt module storing completed travel data associated with the selected route and user.

8. The system of claim 7, wherein the completed travel data includes one or more of: date of travel, time of departure, time of arrival, total travel time, distance travelled, and toll charges accrued.

9. A method for tracking and displaying toll charges in real-time, comprising:
receiving a starting location and a destination location;
calculating one or more routes between the starting location and destination location, including estimating travel time and toll charges along each of the one or more routes;
displaying the one or more routes for user selection;
receiving a selected one of the one or more routes;
monitoring travel along the selected route in real-time and;
displaying real-time updates of estimated arrival time at the destination location, accrued toll charges and future toll charges along the selected route.

10. The method of claim 9, further comprising calculating one or more alternative routes during travel and displaying, for user selection, the alternative routes including changes in estimated arrival time and toll charges for each alternative route compared to the selected route.

11. The method of claim 10, wherein calculating the routes incorporates route warning data.

12. The method of claim 11, wherein the route warning data includes one or more of: construction warnings, accident warnings and police warnings.

13. The method of claim 9, further comprising storing completed travel data associated with the selected route and user.

14. The method of claim 13, wherein the completed travel data includes one or more of: date of travel, time of departure, time of arrival, total travel time, distance travelled, and toll charges accrued.

15. A non-transient computer-readable medium containing instructions for a method of tracking and display toll charges in real-time, the method comprising:
receiving a starting location and a destination location;
calculating one or more routes between the starting location and destination location, including estimating travel time and toll charges along each of the one or more routes;
displaying the one or more routes for user selection;
receiving a selected one of the one or more routes;
monitoring travel along the selected route in real-time and;
displaying real-time updates of estimated arrival time at the destination location, accrued toll charges and future toll charges along the selected route.

16. The non-transient computer-readable medium of claim 15, further the method further comprises calculating one or more alternative routes during travel and displaying, for user selection, the alternative routes including changes in estimated arrival time and toll charges for each alternative route compared to the selected route.

17. The non-transient computer-readable medium of claim 16, wherein calculating the routes incorporates route warning data.

18. The non-transient computer-readable medium of claim 17, wherein the route warning data includes one or more of: construction warnings, accident warnings and police warnings.

19. The non-transient computer-readable medium of claim 15, wherein the method further comprises storing completed travel data associated with the selected route and user.

20. The non-transient computer-readable medium of claim 19, wherein the completed travel data includes one or more of: date of travel, time of departure, time of arrival, total travel time, distance travelled, and toll charges accrued.
